(19) United States
(12) Patent Application Publication
(10) Pub. No.: US 2026/0260890 A1
(43) Pub. Date: Sep. 3, 2026

(54) BATTERY ELECTRODE AND METHOD OF MAKING THE SAME

(71) Applicant: SYENSQO SPECIALTY POLYMERS ITALY S.p.A., Bollate (IT)

(72) Inventors: David James Wilson, LA POMAREDE (FR); Stefano Mauri, Giussano (MB) (IT); Maurizio Biso, Milano (MI) (IT); Riccardo Rino Pieri, Milano (IT)

(73) Assignee: SYENSQO SPECIALTY POLYMERS ITALY S.p.A., Bollate (IT)

(21) Appl. No.: 19/163,787

(22) PCT Filed: Mar. 6, 2024
(86) PCT No.: PCT/EP2024/055775

§ 371 Date: Sep. 9, 2025

(30) Foreign Application Priority Data
Mar. 9, 2023 (EP) 23305314.9

(51) Int. Cl. H01M 4/62; H01G 4/008; H01G 4/01; H01M 4/04; H01M 4/139; H01M 10/058

(52) U.S. Cl. CPC H01M 4/623; H01G 4/008; H01G 4/01; H01M 4/0404; H01M 4/043; H01M 4/139; H01M 4/624; H01M 10/058

(57) ABSTRACT

The present invention relates to an electrode composition comprising PTFE and at least one copolymer of maleic anhydride and di-isobutylene, to a method for its preparation and to its use for the manufacture of electrochemical cell components.

### CROSS REFERENCE TO PREVIOUS APPLICATIONS

This application claims priority to European application No. 23305314.9 filed on 9 Mar. 2023, the whole content of this application being incorporated herein by reference for all purposes.

### TECHNICAL FIELD

The present invention relates to an electrode composition comprising at least one copolymer derived from the polymerization of at least one ethylenically unsaturated, linear or branched, aliphatic, cyclic or aromatic polycarboxylic acid, or anhydride and at least one ethylenically unsaturated, linear or branched aliphatic, cyclic or aromatic hydrocarbon monomer, to a method for its preparation and to its use for the manufacture of electrochemical cell components.

### BACKGROUND ART

To date, the electrodes of a lithium secondary battery are mainly manufactured by a wet process that comprises preparing a slurry in which an electrode active material, additives and a binder are dispersed in a solvent or an aqueous medium, and processing the slurry in a way that forms an electrode film.

Dry electrode processes have been developed to reduce the time-consuming and costly drying procedures required by the aforementioned wet processes.

Typical dry processes use the fibrillation properties of certain polymers to provide a matrix for embedded conductive material. Some of the polymers in the family of fluoropolymers, such as polytetrafluoroethylene (PTFE), are particularly inert and stable in the common electrolyte solvents used in secondary batteries, even those using organic solvent at high working or storage temperatures. Thus, the stability of an electrode made using PTFE can be higher than those made with other binders.

For example, dry electrode preparation processes can include combining a PTFE binder with active electrode material in powder form, and calendering to form an electrode film. However, although PTFE has good adhesiveness to the electrode active material, it has difficulty in adhesiveness to the current collector.

Known in the art are methods to improve the adhesiveness to the current collector and electrode active material of PTFE, by using PTFE and tetrafluoroethylene/hexafluoropropylene copolymer (FEP) in combination as a binder, achieving a material having the melting point of FEP (240 to 270° C.) or higher (JP2000149954A). However, in order to heat to a temperature equal to or higher than the melting point of FEP, specifically, 280° C. or higher, a special heat treatment device is required to provide an electrode film, and it is disadvantageous in terms of energy.

Another drawback of PTFE is related to its limited electrochemical stability at anode side that could result in polymer degradation and in lower coulombic efficiency when used as binder for anodes. Moreover, when the anode is made of silicon, one of the key obstacles to overcome is the significant volume change that occurs in silicon active materials when they absorb (expand) and desorb (contract) lithium during charge-discharge cycles. These substantial shrink-swell cycles impart high mechanical stress on the anode layer causing fractures and contact loss in the circuit that leads to reduced capacity and eventual failure of the electrochemical cell.

To overcome the specific challenges associated with silicon, one approach is to create a self-healing mechanism within the binder matrix by incorporating weak bonding interactions that enable a degree of reversibility, where these labile bonds can be disrupted under stress but reformed upon relaxation without irreparable damage to the active material particles. Unfortunately, PTFE is not able to intimately interact with the active materials through such bonding interactions and is not a good candidate binder for silicon rich anode.

There are many approaches being pursued to develop next generation binders that can be suitable also to accommodate silicon anodes.

There are multiple polycarboxylate binders and derivatives being pursued, including polyacrylic acids, polyamic acids, polyacrylamides, and other hydrogen bonding structures.

The Applicant has unexpectedly found that certain polymers obtained by copolymerization of at least one monomer bearing a maleic anhydride and at least one olefin hydrocarbon monomer may be used in the dry electrode preparation processes, especially for the preparation of silicon-rich anodes, thus providing electrodes by a very efficient process.

### SUMMARY OF INVENTION

It is thus hereby provided a process for manufacturing an electrode [electrode (E)] for electrochemical cell, said process comprising:
i) providing at least one polymer [polymer (A)] derived from the polymerization of at least one monomer (1) and of at least one monomer (II), the said monomers corresponding to the following:
   monomer (1): ethylenically unsaturated, linear or branched, aliphatic, cyclic or aromatic polycarboxylic acid, or anhydride,
   monomer (II): ethylenically unsaturated, linear or branched aliphatic, cyclic or aromatic hydrocarbon monomer;
ii) dry mixing at least one electrode active material (AM), the polymer (A) as above defined, and optionally, at least one conductive agent in the absence of solvent to provide a dry electrode forming composition [composition (C)];
iii) feeding the composition (C) obtained in step ii) to a compactor to form a self-supporting dry film; and
iv) applying the dry film to an electrically conductive substrate to form the electrode.

In another aspect, the present invention provides an electrode (E) for a secondary battery obtainable by the process as above defined.

The Applicant has found that the addition a polymer (A) is particularly effective in ensuring improved adhesion to PTFE when used as binders for electrodes for secondary batteries. The polymer (A) could thus be conveniently used as the only binder or in blend with PTFE granting high adhesion.

It is thus hereby provided a binder composition [binder (B)] for use in the preparation of electrodes for electrochemical devices, characterized by comprising:
a. a polytetrafluoroethylene (PTFE); and
b. at least one polymer (A) as above defined.

The applicant has surprisingly found that the processability of the binder (B) make it suitable for the preparation of electrodes by dry processes or extrusion at low temperatures, thus providing electrodes by a very efficient process.

In another aspect the present invention thus provides a process for manufacturing an electrode [electrode (E1)] for electrochemical cell, said process comprising:
step 1) combining a polytetrafluoroethylene (PTFE) and a polymer (A) as above defined to provide a binder (B);
step II) dry mixing the at least one electrode active material (AM), the binder (B) obtained in step I), and optionally, at least one conductive agent in the absence of solvent to provide a dry electrode forming composition [composition (C1)];
step III) feeding the composition (C1) obtained in step II) to a compactor to form a self-supporting dry film; and
step IV) applying the dry film to an electrically conductive substrate to form the electrode.

In another aspect, the present invention provides an electrode (E1) for a secondary battery obtainable by the process as above defined.

In a further aspect, the present invention relates to an electrochemical device, such as a secondary battery or a capacitor, comprising at least one electrode (E) or electrode (E1) as defined above.

### DESCRIPTION OF EMBODIMENTS

In the context of the present invention, the term “weight percent” (wt %) indicates the content of a specific component in a mixture, calculated as the ratio between the weight of the component and the total weight of the mixture. When referred to the recurring units derived from a certain monomer in a polymer/copolymer, weight percent (wt %) indicates the ratio between the weight of the recurring units of such monomer over the total weight of the polymer/copolymer. When referred to the total solid content of a liquid composition, weight percent (wt %) indicates the ratio between the weight of all non-volatile ingredients in the liquid.

As used herein, the terms “adheres” and “adhesion” indicate that two layers are permanently attached to each other via their surfaces of contact.

By the term “electrochemical device”, it is hereby intended to denote an electrochemical cell/assembly comprising a positive electrode, a negative electrode and a liquid electrolyte, wherein a monolayer or multilayer separator is in contact to at least one surface of one of the said electrodes. Non-limitative examples of suitable electrochemical devices include, notably, secondary batteries, especially, alkaline or an alkaline-earth secondary batteries such as lithium ion batteries, lead-acid batteries, and capacitors, especially lithium ion-based capacitors and electric double layer capacitors (supercapacitors). Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

### The Polymer (A)

Polymer (A) is a copolymer derived from the polymerization of at least one monomer (1) and of at least one monomer (II), wherein
monomer (I): ethylenically unsaturated, linear or branched, aliphatic, cyclic or aromatic polycarboxylic acid, or anhydride,
monomer (II): ethylenically unsaturated, linear or branched aliphatic, cyclic or aromatic hydrocarbon monomer.

By “copolymer” as used herein it is intended to denote a polymer having two or more different monomer units. The copolymer could be a terpolymer with three or more different monomer units, or have four or more different monomer units. The copolymer may be a random copolymer, a gradient copolymer, or a block copolymer formed by a controlled polymerization process. Preferably, the copolymer is formed by a free radical polymerization process or an anionic polymerization process, and the process can be any polymerization method known in the art, including but not limited to solution, suspension polymerization, and can be done in bulk, and semi-bulk.

The monomer (1) is preferably a monomer of the following formula:

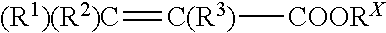

wherein the radicals R¹, R² and R³, which are identical or different, are selected from the group consisting of a hydrogen atom, a C₁-C₁₀ hydrocarbon radical optionally comprising a —COOH group, and a —COOH group, wherein at least one of R¹, R² and R³ is not a hydrogen atom; R^{X} is selected from a hydrogen atom or a C₁-C₂₀ hydrocarbon moiety comprising at least one carboxyl functional group, wherein the —COOH group of any of R¹ and R² can optionally be at least in part taken together with the group COOR^{X} to form an anhydride.

According to a preferred embodiment of the invention, the monomer (1) is a polycarboxylic acid, or a carboxylic anhydride corresponding to the following formula:

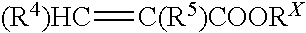

wherein: R⁴ is selected from the group consisting of a hydrogen atom, a —COOH group or a —(CH₂)ₙ—COOH group in which n is between 1 and 4, or a C₁-C₄ alkyl radical;
R⁵ is selected from the group consisting of a hydrogen atom, a —(CH₂)ₘ—COOH group in which m is between 1 and 4, or a C₁-C₄ alkyl radical; wherein at least one of R⁴ and R⁵ is not a hydrogen atom; R^{X} is as above defined.

Preferably, R⁴ is selected from the group consisting of a hydrogen atom, a group —COOH or (CH₂)—COOH, a methyl radical, and R⁵ is selected from the group consisting of a hydrogen atom, a group —CH₂COOH or a methyl radical, wherein at least one of R⁴ and R⁵ is not a hydrogen atom.

According to a more specific embodiment, the monomer (1) is selected from the group consisting of: citraconic, maleic, fumaric or itaconic acids, esters or anhydrides; (meth) acryloyloxyalkyl succinic acid, such as (meth) acryloyloxyethyl succinic acid and (meth) acryloyloxypropyl succinic acid.

Still more preferably, monomer (I) is maleic anhydride.

The monomer (II) is preferably a monomer of the following formula:

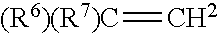

wherein the radicals R⁶ and R⁷, which are identical or different, are selected from the group consisting of a hydrogen atom or a linear or branched, aliphatic, or cyclic, saturated or ethylenically unsaturated C₁-C₁₀ radical.

More particularly, the said radicals R⁶ and R⁷, which are identical or different, are selected from the group consisting of a hydrogen atom or a saturated, linear or branched aliphatic, or cyclic, C₁-C₁₀ radical.

Preferably, the said monomer (II) is selected from the group consisting of: ethylene, propylene, 1-butene, isobutylene, n-1-pentene, 2-methyl-1-butene, n-1-hexene, 2-methyl-1-pentene, 4-methyl-1-pentene, 2-ethyl-1-butene, di-isobutylene (or 2,4,4-trimethyl-1-pentene), 2-methyl-3,3-dimethyl-1-pentene.

In one embodiment of the present application, polymer (A) is preferably a copolymer of maleic anhydride and di-isobutylene.

In one embodiment, the polymer (A) is more particularly a copolymer of 40% to 60% by moles of monomer (1) and 60% to 40% by moles of monomer (II).

In a preferred embodiment of the present invention, polymer (A) is a copolymer of maleic anhydride and di-isobutylene that contains about

40% to 60% by moles, preferably about 50% by moles of maleic anhydride monomer units and 60% to 40% by moles, preferably about 50% by moles of di-isobutylene monomer units.

The molecular weight Mw of the copolymer used as polymer (A) is generally between 10 000 Da and 500 000 Da, preferably between 15 000 Da and 75 000 Da.

The polymer (A) is prepared by polymerizing a mixture of monomer (I) and monomer (II), optionally in the presence of other alpha, beta-ethylenically unsaturated monomers, such as acrylonitrile, N-vinylimidazole, N-vinylpyrrolidone, vinylphosphonic acid.

The polymer (A) suitably has an average particle size (D50) in the range of from 5 to 250 μm.

The average particle size of the positive electrode active material can be measured by a particle size distribution meter for dynamic light scattering.

The polymer (A) may further be at least partially neutralized to obtain at least a fraction of the carboxylic acid or anhydride moieties in the form of a salt.

In an embodiment of the present invention, it is thus provided a composition (C) comprising a copolymer of monomer (1) and monomer (II) (polymer (A)) that is at least partially salified.

The preparation of polymer (A) may thus further include a step of neutralization of at least a fraction of anhydride or carboxyl groups with a salt [salt (SA)] including a monovalent or a divalent cation in a suitable solvent.

The salt (SA) can be any salt capable of neutralizing the anhydride or carboxylic acid groups, and it is preferably selected from a salt capable of providing an alkali metal cation, an alkaline earth metal cation, a tertiary or quaternary ammonium cation, more preferably Na⁺, K⁺, Li⁺ and or quaternary ammonium cation.

### The Electrode Active Material (AM)

For the purpose of the present invention, the term “electrode active material” is intended to denote a compound that is able to incorporate or insert into its structure, and substantially release therefrom, alkaline or alkaline-earth metal ions during the charging phase and the discharging phase of an electrochemical device. The electrode active material is preferably able to incorporate or insert and release lithium ions.

The nature of the electrode active material (AM) depends on whether said composition is used in the manufacture of a negative electrode (anode) or a positive electrode (cathode).

In the case of forming a positive electrode for a Lithium-ion secondary battery, the electrode active material may comprise a composite metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1) and spinel-structured LiMn₂O₄.

As an alternative, still in the case of forming a positive electrode for a Lithium-ion secondary battery, the electrode active material may comprise a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M2 metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electrode active material in the case of forming a positive electrode has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electrode active material is a phosphate-based electro-active material of formula Li(FeₓMn₁₋ₓ)PO₄ wherein 0≤x≤1, wherein x is preferably 1 (that is to say, lithium iron phosphate of formula LiFePO₄).

As a further alternative, still in the case of forming a positive electrode for a Lithium-ion secondary battery, the electrode active material may comprise garnet-type inorganic particle Li₇La₃Zr₂O₁₂ (LLZO) or doped-LLZO inorganic particle having a general formula of LiₓLa_{y}Zr₂A_{w}O₁₂, wherein:
A represents one or several dopants selected from the group consisting of Al, Ga, Nb, Fe, Nd, Pt, Ta, W, Mo, Hf, Si, Ca, Sr, Ba, Ge, and mixtures thereof; preferably from the group consisting of Al, Ga, Nb, Fe, Nd, Pt, Ta, W, and mixtures thereof; more preferably from the group consisting of Al, Ga, W, and mixtures thereof;
w, x, y, and z are positive numbers, including various combinations of integers and fractions or decimals;
0<y≤3; preferably 2≤y≤3; preferably 2.5≤y≤3;
0<z≤2; preferably 1≤z≤2; preferably 1.55≤z≤2;
0≤w≤0.5; preferably 0≤w≤0.35; more preferably 0≤w≤0.25; and
x is derived from electroneutrality of the garnet structure; and
combinations thereof.

In the case of forming a positive electrode for a sodium-ion secondary battery, the electrode active material may comprise Na-based layered transition-metal oxides, Prussian blue analogs and polyanion-type materials.

In some embodiments the active materials are Na-based layered transition-metal oxides classified as O3-, P2-, and P3-types depending on the stacking sequence of oxygen layers. P2-type structures generally respond to the general formula NaxMO₂ wherein M stands for a transition metal ion such as Co, Mn and x is 2/3.

In some embodiments the active materials are Prussian blue analogs (PBA) of general formula AₓP[R(CN)₆]_{1-y□y}·mH₂O with A and alkali metal ion, P a N-coordinated transition metal ion, R a C-coordinated transition metal ion, □a [R(CN)₆] vacancy, with 0≤x≤2 and 0≤y<1 such as Na_{0.81}Fe[Fe(CN)₆]_{0.79□0.21}, NaFe₂(CN)₆, Na1_{.63}Fe_{1.89}(CN)₆, Na_{1.72}MnFe(CN)₆, Na_{1.76}Ni_{0.12}Mn_{0.88}[Fe(CN)₆]_{0.98}, Na₂NiₓCo₁₋ₓFe(CN)₆ with 0≤x≤1 e.g. Na₂CoFe(CN)₆.

In some other embodiments the active materials are polyanion-type materials of general formula NaₓM_{y}(XO₄)ₙ (where X═S, P, Si, As, Mo and W and M is transition metal), which possess a series of tetrahedron anion units (XO₄)ⁿ⁻ and their derivatives (XₘO₃ₘ₊₁)ⁿ⁻. Among them, phosphates NaMPO₄ such as NaFePO₄, Na_{0.7}FePO₄ or NaMnPO₄; natrium (sodium) superionic conductor of NASICON-type structures of general formula NaₓM₂(XO₄)₃ (where 1≤x≤4 and
M=V, Fe, Ni, Mn, Ti, Cr, Zr . . . ; X═P, S, Si, Se, Mo . . . )—with single transition metal type such as Na₃V₂(PO₄)₃ (NVP), Na₃Cr₂(PO₄)₃, Na₃Fe₂(PO₄)₃; —with binary transition metal type such as Na₂VTi(PO₄)₃, Na₃FeV(PO₄)₃, Na₄MnV(PO₄)₃, Na₃MnZr(PO₄)₃, Na₃MnTi(PO₄)₃, Na₄Fe₃(PO₄)₂(P₂O₇) (NFPP); pyrophosphates Na₂FeP₂O₇, Na₂MnP₂O₇, Na₂CoP₂O₇, Na₄₋ₓFe_{2+x/2}(P₂O₇)₂ with 2/3≤x≤7/8 e.g. Na_{3.12}Fe_{2.44}(P₂O₇)₂ or Na_{3.32}Fe_{2.34}(P₂O₇)₂, Na₂(VO)P₂O₇, Na₇V₃(P₂O₇)₄; fluorophosphates NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF); fluoro sulfates such as NaMSO₄F (with M=Fe, Co, Ni); mixed phosphates/pyrophosphates of general formula Na₄M₃(PO₄)₂(P₂O₇) (with M representing transition metals) such as Na₄Mn₃(PO₄)₂(P₂O₇), Na₄Co₃(PO₄)₂(P₂O₇), Na₄Ni₃(PO₄)₂(P₂O₇), Na₄Fe₃(PO₄)₂(P₂O₇) (NFPP), Na₇V₄(P₂O₇)₄(PO₄); sulfates such as Na₂Fe₂(SO₄)₃, Na₂₊₂ₓFe₂₋ₓ(SO₄)₃, Na₂₊₂ₓCo₂₋ₓ(SO₄)₃, Na₂₊₂ₓMn₂₋ₓ(SO₄)₃ (where 0≤x≤1); silicates of general formula Na₂MSiO₄ (with M=Mn, Fe, Co and Ni).

In some preferred embodiments the active materials are fluorophosphates preferably selected from the list consisting of NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF).

In the case of forming a negative electrode for a secondary battery, the electrode active material may preferably comprise materials selected from the group consisting of one or more carbon-based materials and one or more silicon-based materials.

In some embodiments, the carbon-based materials may be selected from graphite, such as natural or artificial graphite, graphene, or carbon black.

These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide.

More particularly, the silicon-based compound may be silicon oxide or silicon carbide.

The silicon oxide may comprise, in particular, particles with formula SiOₓ with 0.5≤x≤1 that are lithiated material yielding to the formation of Li₄SiO₄ and Li₂SO₃, as disclosed in WO2015/063979.

When present in the electrode active material, the silicon-based compounds are comprised in an amount ranging from 1 to 60% by weight, preferably from 5 to 30% by weight with respect to the total weight of the electro active compounds.

Composition (C) may further comprise one or more optional electroconductivity-imparting additives, which may be added in order to improve the conductivity of a resulting electrode made from the composition (C).

Conducting agents for batteries are known in the art.

Examples thereof may include: carbonaceous materials, such as carbon black, graphite fine powder, carbon nanotubes, graphene, or fiber, or fine powder or fibers of metals such as nickel or aluminum. The optional conductive agent is preferably carbon black. Carbon black is available, for example, under the brand names, Super P® or Ketjenblack®.

When present, the conductive agent is different from the carbon-based material described above.

The amount of optional conductive agent is preferably from 0 to 30 wt % of the total solids in the electrode forming composition. In particular, for cathode forming compositions the optional conductive agent is typically from 0 wt % to 10 wt %, more preferably from 0 wt % to 5 wt % of the total amount of the solids within the composition.

For anode forming compositions which are free from silicon based electro active compounds the optional conductive agent is typically from 0 wt % to 5 wt %, more preferably from 0 wt % to 2 wt % of the total amount of the solids within the composition, while for anode forming compositions comprising silicon based electro active compounds it has been found to be beneficial to introduce a larger amount of optional conductive agent, typically from 0.5 to 30 wt % of the total amount of the solids within the composition.

In step ii) of the process of the present invention, mixing electrode active material (AM), the polymer (A) as above defined, and optionally, at least one conductive agent is performed by dry-blending these ingredients without the addition of any solvents, liquids, processing aids, or the like to the particle mixture. Dry-mixing may be carried out, for example, in a mill, mixer or blender (such as a V-blender equipped with a high intensity mixing bar, or other alternative equipment as described further below), until a uniform dry mixture is formed. Those skilled in the art will identify, after perusal of this document, that blending time can vary based on batch size, materials, particle size, densities, as well as other properties, and yet remain within the scope hereof.

In step iii) of the process of the invention, the powdered dry mixture obtained in step ii) is subjected to mechanical compaction step to provide a self-supporting dry film.

The compacting of the dry mixture obtained in step ii) can take place as a mechanical compaction, for example by means of a roller compactor or a tablet press, but it can also take place as rolling, build-up or by any other technique suitable for this purpose.

The mechanical compaction step may be associated to a thermal consolidation step. The combination of an applied pressure and a heat treatment makes thermal consolidation possible at lower temperatures than if it were done alone.

In one embodiment, the mechanical compaction step is carried out by compression, suitably by compressing the dry mixture obtained in step ii) between two metal foils. Preferably, the mechanical compaction step is done by application of a compression pressure between 5 and 50 MPa, and preferably between 10 and 30 MPa.

The compaction step is conveniently carried out at a temperature not exceeding 200° C., preferably at a temperature lower than 180° C.

In step iv), the dry film obtained in step iii) is applied onto an electrically conductive substrate to form the electrode.

The sheet of substrate material may comprise a metal foil, an aluminum foil in particular.

Thanks to the improved adhesion of the composition (C), the dry film obtained in step iii) can be applied onto the electrically conductive substrate without the need for any primer or adhesive layer.

Steps i) to iv) can be performed as a single step, or as separate steps, some of the steps may be separated and/or combined functionally during performance of some embodiments.

The polymer (A) could be conveniently used as the only binder in the preparation of electrodes according to the process of the present invention, or it can be used in blend with PTFE.

According to another aspect of the present invention, it is thus provided a process for manufacturing an electrode [electrode (E1)] for electrochemical cell, said process comprising:
step I) combining a polytetrafluoroethylene (PTFE) and a polymer (A) as above defined to provide a binder (B);
step II) dry mixing the at least one electrode active material (AM), the binder (B) as above defined, and optionally, at least one conductive agent in the absence of solvent to provide a dry electrode forming composition [composition (C1)];
step III) feeding the composition (C1) obtained in step II) to a compactor to form a self-supporting dry film; and
step IV) applying the dry film to an electrically conductive substrate to form the electrode.

In the context of the present invention, the term “PTFE” indicates a polymer obtained from the polymerization of tetrafluoroethylene (TFE).

It is understood, however, that the PTFE polymer may also comprise minor amounts of one or more co-monomers such as, but not limited to, hexafluoropropylene, perfluoro(methyl vinyl ether), perfluoro(propyl vinyl ether), perfluoro-(2,2-dimethyl-1,3-dioxole), and the like, provided, however that the latter do not significantly adversely affect the unique properties of the tetrafluoroethylene homopolymer, such as thermal and chemical stability. Preferably, the amount of such co-monomer does not exceed about 3% by moles, and more preferably less than about 1% by moles; particularly preferred is a co-monomer content of less than 0.5% by moles. In the case that the overall co-monomer content is greater than 0.5% by moles, it is preferred that the amount of the perfluoro(alkyl vinylether) co-monomer is less than about 0.5% by moles. Most preferred are PTFE homopolymers.

The PTFE suitable for use in the preparation of the binder (B) of the present invention can be in the form of powder or in the form of latex.

PTFE in the form of powder may be obtained by coagulating PTFE lattices by means of cryogenic coagulation or by electrolytic coagulation with the addition of an electrolyte. See, for example, U.S. Pat. No. 6,790,932. Preferred examples of electrolytes are:
Aluminum sulphate (Al₂(SO₄)₃), in concentration of 2 g/l calculated on amount of water in the coagulation vessel,
Ammonium carbonate ((NH₄)₂CO₃), in concentration of 8 g/l calculated on amount of water in the coagulation vessel, or
Nitric acid (HNO₃), 25 ml of a solution at 65% calculated on amount of water in the coagulation vessel.

Alternatively, the powder of PTFE may be obtained from PTFE lattices in the form of gels by means of coagulation with the electrolytes mentioned above. The gels may be obtained according to U.S. Pat. Nos. 6,790,932 and 6,780,966.

After the coagulation occurred, the polymer is washed at room temperature with demineralized water. After coagulation and washing, the PTFE powder obtained therein is then dried.

The PTFE lattices are generally obtained by dispersion or emulsion polymerization.

The PTFE in the form of powder generally has a particle size of between 1 and 1600 microns, preferably from 100 to 800 microns and more preferably 400-700 microns.

Particle size can be expressed in terms of D50, which is the corresponding particle size when the cumulative percentage reaches 50%. D50 is also called as the median particle diameter or median particle size. For example, for a powder sample with D50=5 μm, it means 50% of particles are larger than 5 μm and 50% particles are smaller than 5 μm.

Binder (B) may be obtained by mixing the PTFE and the polymer (A) both in the powder form or through mixing of a PTFE latex with a polymer (A) latex, followed by co-coagulation by cryogenic or electrolytic procedure and isolation.

In order to obtain the desired polymer ratio in the blend, the dry content of the PTFE latex and/or the polymer (A) latex may be evaluated by drying in a thermobalance 50 grams of polymeric latex at 200° C.

Generally the weight ratio PTFE/polymer (A) will be comprised between 95/5 wt/wt to 30/70 wt/wt. The skilled in the art will select most appropriate weight ratio in view of target final properties of the binder (B).

The applicant has surprisingly found that an amount of polymer (A) added to PTFE does not affect the ability to fibrillate PTFE.

The amount of binder (B) which may be used in the electrode-forming composition (C1) is subject to various factors. One such factor is the surface area and amount of the active material, and the surface area and amount of any electroconductivity-imparting additive which are added to the electrode-forming composition. These factors are believed to be important because the binder particles provide bridges between the conductor particles and conductive material particles, keeping them in contact.

The composition (C1) includes one or more electrode active material (AM) as above defined.

Dry mixing step II) involves the fibrillization of the binder particles to produce fibrils that eventually form a matrix for supporting the resulting composition of matter. The resulting dough-like material may be calendared many times to produce a conductive film of desired thickness and density. The mixing can be provided by subjecting the mixture to an extruder.

The same details provided above with regard to steps A) to D) apply respectively to steps I) to IV).

Steps I) to IV) can be performed as a single step, or as separate steps; some of the steps may be separated and/or combined functionally during performance of some embodiments.

The composition (C) or the composition (C1) obtained in step B) or in step II) of the processes according to the present invention may further include at least one sulfide-based solid electrolyte.

When the composition (C) or the composition (C1) used in the processes according to the present invention includes at least one sulfide-based solid electrolyte or at least one garnet-type inorganic particle based solid electrolyte, the present invention provides electrodes suitable for use in solid-state batteries obtainable by the processes as above defined [electrode (ESS)].

Thus, in one embodiment, the present invention provides a process for manufacturing an electrode for solid-state batteries [electrode (ESS)], said process comprising:
a) providing a polymer (A) as above defined;
b) dry mixing at least one electrode active material (AM), the polymer (A) provided in step A) as above defined, at least one sulfide-based solid electrolyte or at least one garnet-type inorganic particle based solid electrolyte and, optionally, at least one conductive agent in the absence of solvent to provide a dry electrode forming composition [composition (C′)];
c) feeding the composition (C′) obtained in step B) to a compactor to form a self-supporting dry film; and
d) applying the dry film to an electrically conductive substrate to form the electrode.

The same details provided above with regard to steps A) to D) apply respectively to steps a) to d).

In another embodiment the present invention provides a process for manufacturing an electrode for solid-state batteries [electrode (ESS-1)], said process comprising:
step I′) combining a polytetrafluoroethylene (PTFE) and a polymer (A) as above defined to provide a binder (B);
step II′) dry mixing the at least one electrode active material (AM), the binder (B) as above defined, at least one sulfide-based solid electrolyte and, and optionally, at least one conductive agent in the absence of solvent to provide a dry electrode forming composition [composition (C1′)];
step III′) feeding the composition (C1′) obtained in step B) to a compactor to form a self-supporting dry film; and
step IV′) applying the dry film to an electrically conductive substrate to form the electrode.

The same details provided above with regard to steps A) to D) apply respectively to steps I′) to IV′).

As used here, the phrase “sulfide-based solid electrolyte,” refers to an inorganic solid state material that conducts Li⁺ ions but is substantially electronically insulating.

In the present invention, the term “sulfide-based solid ionic conducting inorganic particle” is not particularly limited as long as it is a solid electrolyte material containing sulfur atom(s) in the molecular structure or in the composition.

The sulfide-based solid ionic conducting inorganic particle preferably contains Li, S, and an element of from 13 to 15 groups, for instance, P, Si, Sn, Ge, Al, As, Sb, or B, to increase Li-ion conductivity.

The sulfide-based solid ionic conducting inorganic particle according to the present invention is preferably selected from the group consisting of:
lithium tin phosphorus sulfide (“LSPS”) materials, such as Li₁₀SnP₂S₁₂;
lithium phosphorus sulfide (“LPS”) materials, such as glass, crystalline or glass-ceramic of those of formula (Li₂S)ₓ—(P₂S₅)_{y}, wherein x+y=1 and 0≤x≤1, Li₇P₃S₁₁, Li₇PS₆, Li₄P₂S₆, Li_{9.6}P₃S₁₂ and Li₃PS₄;
doped LPS, such as Li₂CuPS₄, Li₁₊₂ₓZn₁₋ₓPS₄, wherein 0≤x≤1, Li_{3.33}Mg_{0.33}P₂S₆, and Li₄₋₃ₓScₓP₂S₆, wherein 0≤x≤1;
lithium phosphorus sulfide oxygen (“LPSO”) materials of formula LiₓP_{y}S_{z}O_{w}, wherein 0.33≤x≤0.67, 0.07≤y≤0.2, 0.45≤z≤0.55;
lithium phosphorus sulfide materials including X (“LXPS”), wherein X is Si, Ge, Sn, As, or Al, such as Li₁₀SnP₂S₁₂, Li₁₀GeP₂S₁₂, Li₁₀SiP₂S₁₂, and Li₂S—P₂S₅—SnS;
lithium phosphorus sulfide oxygen including X (“LXPSO”), wherein X is Si, Ge, Sn, As, or Al;
lithium silicon sulfide (“LSS”) materials, such as Li₂SiS₃, Li₂S—P₂S₅—SiS₂, Li₂S—P₂S₅—SiS₂—LiCl, Li₂S—SiS₂—P₂S₅, Li₂S—SiS₂—P₂S₅—LiI, Li₂S—SiS₂—LiI, Li₂S—SiS₂, Li_{9.54}Si_{1.74}P_{1.44}S_{11.7}Cl_{0.3}, and Li₂S—SiS₂—Al₂S₃;
lithium boron sulfide materials, such as Li₃BS₃ and Li₂S—B₂S₃—LiI;
lithium tin sulfide materials and lithium arsenide materials, such as Li_{0.8}Sn_{0.8}S₂, Li₄SnS₄, Li_{3.833}Sn_{0.833}As_{0.166}S₄, Li₃AsS₄—Li₄SnS₄, and Ge-substituted Li₃AsS₄;
lithium phosphorus sulfide materials of general formula LiₐPS_{b}X_{G}, wherein X represents at least one halogen element selected from the group consisting of C1, Br and I or a combination thereof; and a represents a number from 2.0 to 7.0, b represents a number from 3.5 to 6.0, and c represents a number from 0 to 3.0, such as Li₄PS₄Cl, Li₇P₂S₈Cl, and Li₇P₂S₈I.

In a more preferred embodiment, the sulfide-based solid ionic conducting inorganic particle is a lithium phosphorus sulfide material of the above general formula LiₐPS_{b}X_{c}, more particularly Argyrodite-type sulfide material of formula Li₆PS₅X, wherein X is Cl, Br or I.

In another preferred embodiment, the Argyrodite-type sulfide material of formula Li₆PS₅Y is deficient in sulfur and/or lithium, for instance Li₆₋ₓPS₅₋ₓCl₁₊ₓ with 0≤x≤0.5, or doped with a heteroatom.

Particularly preferred sulfide solid electrolytes are LPS materials, LSPS materials and Argyrodite-type sulfide materials.

Electrode (E), electrode (E1) and electrode (ESS) of the present invention are particularly suitable for use in electrochemical devices, in particular in secondary batteries.

In one aspect, the present invention provides an electrochemical device being a secondary battery comprising:
a positive electrode and a negative electrode,
   wherein at least one of the positive electrode and the negative electrode is an electrode (E), (E1) or (ESS) according to the present invention.

In a further object, the present invention provides a solid state battery comprising a composite solid electrolyte film, a positive electrode and a negative electrode,
wherein at least one of the negative electrode or the positive electrode is an electrode (ESS) according to the invention.

The secondary battery of the invention is preferably an alkaline or an alkaline-earth secondary battery.

The secondary battery of the invention is more preferably a lithium-ion secondary battery.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit scope of the invention.

### EXAMPLES

### Raw Materials

Polymer (A-1): maleic anhydride/di-isobutylene copolymer neutralized with NaOH, available from Solvay as Geropon® T36.

Silicon oxide, KSC-1064 commercially available from Shin-Etsu, theoretical capacity is about 2100 mAh/g;
Graphite, GHDR 15-4 commercially available from Imerys S.A.;
Carbon black, commercially available as SC45 from Imerys S.A.;
Carbon black, commercially available as SC65 available from Imerys S.A.;
PTFE: PTFE homopolymer powder having specific gravity, measured according to ASTM D792, of 2160 and having rheometric pressure, measured according to ASTM D4895, of 9.50 MPa;
Lithium Iron Phosphate, LFP, available as Life Power from Johnson Matthey;
Galden HT80 commercially available from Solvay Materials;

### Dry Process Anode According to the Invention:

A dry mixture of 5.41 g of graphite, 1.36 g of silicon oxide and 0.072 g of SC45 was prepared by grinding for 10 minutes the powders in an electric mortar.

5 ml of Galden HT80 was added to the powder mixture and the composite mixed in electric mortar for 1 minute. A homogeneous paste was obtained.

0.29 g of Polymer (A-1) powder, 0.07 g of PTFE with 4 ml of Galden HT80 were added to the homogeneous paste and mixed in a mortar grinder for 5 min. A homogeneous composite was obtained.

The composite was then manipulated manually in order to fibrillate the polymer and obtain gross and cohese self-standing film.

Film was calendered to lower the thickness below 200 μm.

The resulting negative electrode had the following composition: 75.2 wt. % of graphite, 18.8 wt. % of silicon, 4 wt. % of polymer (A-1), 1% PTFE and 1 wt. % of carbon black.

Negative electrode NE1 was thus obtained.

A negative electrode NE1 sample was placed between two copper current collectors and preheated at 150° C. for 10 minutes in a press. Then 160 Bars was applied for 10 minutes to laminate the NE1 to current collector at a temperature of 150° C. and at a pressure of 160 Bars. Press was then cooled down to room temperature without releasing the pressure.

### Dry Process Cathode According to the Invention

A dry mixture of 6.48 g of LFP and 0.36 g of SC65 was prepared by grinding for 10 minutes the powders in an electric mortar.

4 ml of Galden HT80 was added to the powder mixture and the composite mixed in electric mortar for 1 minute. A homogeneous paste was obtained.

0.18 g of Polymer (A-1) powder, 0.18 g of PTFE with 3 ml of Galden HT80 were added to the homogeneous paste and mixed in a mortar grinder for 5 min. A homogeneous composite was obtained.

The composite was then manipulated manually in order to fibrillate the polymer and obtain gross and cohese self-standing film.

The film was calendered to lower the thickness below 200 μm.

The resulting positive electrode had the following composition: 90 wt. % of LFP, 2.5 wt. % of polymer (A), 2.5% PTFE and 5 wt. % of carbon black.

Positive Electrode 1 (PE1) was thus obtained.

A PE1 sample was placed between two aluminum current collectors and preheated at 150° C. for 10 minutes in a press. Then 160 Bars was applied for 10 minutes to laminate PE1 to current collector at a temperature of 150° C. and at a pressure of 160 Bars. Press was then cooled down to room temperature without releasing the pressure.

### Dry Process Anode—Comparative

A dry mixture of 5.41 g of graphite, 1.36 g of silicon oxide and 0.072 g of SC45 was prepared by grinding for 10 minutes the powders in an electric mortar.

5 ml of Galden HT80 was added to the powder mixture and the composite mixed in electric mortar for 1 minute. A homogeneous paste was obtained.

0.36 g of PTFE with 4 ml of Galden HT80 were added to the homogeneous paste and mixed in a mortar grinder for 5 min. A homogeneous composite was obtained.

The composite was then manipulated manually in order to fibrillate the polymer and obtain gross and cohese self-standing film.

A film was calendered to lower the thickness below 200 μm.

The resulting negative electrode had the following composition: 75.2 wt. % of graphite, 18.8 wt. % of silicon, 2.5% PTFE and 1 wt. % of carbon black.

Electrode CE1 was thus obtained.

The CE1 sample was placed between two copper current collectors and preheated at 150° C. for 10 minutes in a press. Then 160 Bars was applied for 10 minutes to laminate CE1 to current collector at a temperature of 150° C. and at a pressure of 160 Bars. Press was then cooled down to room temperature without releasing the pressure.

### Dry Process Cathode—Comparative

A dry mixture of 6.48 g of LFP and 0.36 g of SC65 was prepared by grinding for 10 minutes the powders in an electric mortar.

4 ml of Galden HT80 was added to the powder mixture and the composite mixed in electric mortar for 1 minute. A homogeneous paste was obtained.

0.36 g of PTFE with 3 ml of Galden HT80 were added to the homogeneous paste and mixed in a mortar grinder for 5 min. A homogeneous composite was obtained.

The composite was then manipulated manually in order to fibrillate the polymer and obtain gross and cohese self-standing film.

A film was calendered to lower the thickness below 200 μm.

The resulting positive electrode had the following composition: 90 wt. % of LFP, 2.5% PTFE and 5 wt. % of carbon black.

Electrode CE2 was thus obtained.

The CE2 sample was placed between two aluminum current collectors and preheated at 150° C. for 10 minutes in a press. Then 160 Bars was applied for 10 minutes to laminate CE2 to current collector at a temperature of 150° C. and at a pressure of 160 Bars. Press was then cooled down to room temperature without releasing the pressure.

### Adhesion Assessment and Measure

Adhesion assessment and measurements were carried out between the laminated sample as above specified and foil by following ASTM D 1876 on the 3 layer structure obtained after the lamination (metal foil/film/metal foil). The adhesion levels are reported in Table 1.

A larger value for the peel strength indicates better close adherence between the polymer and the current collector.

TABLE 1

| | Anode Adhesion | Cathode Adhesion |
|---|---|---|
| ELECTRODE | level to Cu* | level to Al* |
| CE1 | D | / |
| NE1 | B | / |
| CE2 | / | D |
| PE1 | / | A |

*A: Peel strength of at least 5.0 N/m
B: Peel strength of at least 0.1 N/m and less than 5.0 N/m
C: Adhesion obtained, difficult to measure due to rigidity of specimen
D: No adhesion

No adhesion was observed with PTFE powders when employed alone in the preparation of films by compression between two aluminum foils nor between two copper foils.

1. A process for manufacturing an electrode [electrode (E)] for electrochemical cell, said process comprising:
i) providing at least one polymer [polymer (A)] derived from the polymerization of at least one monomer (I) and of at least one monomer (II), the said monomers corresponding to the following:
monomer (I): ethylenically unsaturated, linear or branched, aliphatic, cyclic or aromatic polycarboxylic acid, or anhydride,
monomer (II): ethylenically unsaturated, linear or branched aliphatic, cyclic or aromatic hydrocarbon monomer;
ii) dry mixing at least one electrode active material (AM), the polymer (A) as above defined, and optionally, at least one conductive agent in the absence of solvent to provide a dry electrode forming composition [composition (C)];
iii) feeding the composition (C) obtained in step ii) to a compactor to form a self-supporting dry film; and
iv) applying the dry film to an electrically conductive substrate to form the electrode.

2. The process according to claim 1, wherein monomer (I) is a monomer of the following formula: 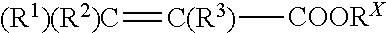
wherein the radicals R¹, R² and R³, which are identical or different, are selected from the group consisting of a hydrogen atom, a C₁-C₁₀ hydrocarbon radical optionally comprising a —COOH group, and a —COOH group, wherein at least one of R¹, R² and R³ is not a hydrogen atom;
R^{X} is selected from a hydrogen atom or a C₁-C₂₀ hydrocarbon moiety comprising at least one carboxyl functional group,
wherein the —COOH group of any of R¹ and R² can optionally be at least in part taken together with the group COOR^{X} to form an anhydride.

3. The process according to claim 2, wherein the monomer (I) is selected from the group consisting of: citraconic, maleic, fumaric or itaconic acids, esters or anhydrides; (meth) acryloyloxyalkyl succinic acid, such as (meth) acryloyloxyethyl succinic acid and (meth) acryloyloxypropyl succinic acid.

4. The process according to claim 1, wherein monomer (II) is a monomer of the following formula: 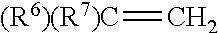
wherein the radicals R⁶ and R⁷, which are identical or different, are selected from the group consisting of a hydrogen atom or a linear or branched, aliphatic, or cyclic, saturated or ethylenically unsaturated C₁-C₁₀ radical.

5. The process according to claim 4, wherein monomer (II) is chosen from ethylene, propylene, 1-butene, isobutylene, n-1-pentene, 2-methyl-1-butene, n-1-hexene, 2-methyl-1-pentene, 4-methyl-1-pentene, 2-ethyl-1-butene, diisobutylene (or 2,4,4-trimethyl-1-pentene), 2-methyl-3,3-dimethyl-1-pentene, preferably monomer (II) is diisobutylene.

6. The process according to claim 1, wherein polymer (A) is a copolymer of maleic anhydride and di-isobutylene monomer units.

7. The process according to claim 1, wherein polymer (A) is at least partially salified.

8. An electrode (E) for a secondary battery obtained by the process according to claim 1.

9. A binder composition [binder (B)] for use in the preparation of electrodes for electrochemical devices, characterized by comprising:
a. a polytetrafluoroethylene (PTFE); and
b. at least one polymer (A) derived from the polymerization of at least one monomer (I) and of at least one monomer (II), the said monomers corresponding to the following:
monomer (I): ethylenically unsaturated, linear or branched, aliphatic, cyclic or aromatic polycarboxylic acid, or anhydride,
monomer (II): ethylenically unsaturated, linear or branched aliphatic, cyclic or aromatic hydrocarbon monomer.

10. The binder (B) according to claim 9, wherein the weight ratio PTFE/polymer (A) is comprised between 95/5 wt/wt to 30/70 wt/wt.

11. A process for manufacturing an electrode [electrode (E1)] for electrochemical cell, said process comprising:
step I) combining a polytetrafluoroethylene (PTFE) and at least one polymer (A) derived from the polymerization of at least one monomer (I) and of at least one monomer (II), the said monomers corresponding to the following:
monomer (I): ethylenically unsaturated, linear or branched, aliphatic, cyclic or aromatic polycarboxylic acid, or anhydride,
monomer (II): ethylenically unsaturated, linear or branched aliphatic, cyclic or aromatic hydrocarbon monomer,
to provide a binder (B);
step II) dry mixing the at least one electrode active material (AM), the binder (B) provided in step I), and optionally, at least one conductive agent in the absence of solvent to provide a dry electrode forming composition [composition (C1)];
step III) feeding the composition (C1) obtained in step II) to a compactor to form a self-supporting dry film; and
step IV) applying the dry film to an electrically conductive substrate to form the electrode.

12. An electrode (E1) for a secondary battery obtained by the process according to claim 11.

13. (canceled)

14. (canceled)

15. An electrochemical device, wherein at least one of the positive electrode or the negative electrode is the electrode (E) according to claim 8.

16. An electrochemical device, wherein at least one of a positive electrode or a negative electrode is the electrode (E1) according to claim 12.
